(19) United States
(12) Patent Application Publication
(10) Pub. No.: US 2002/0132364 A1
(43) Pub. Date: Sep. 19, 2002

(54) Quant-screentm chemiluminescent assays

(76) Inventors: Corinne E.M. Olesen, Bedford, MA (US); Yu-xin Yan, Burlington, MA (US); Irena Y. Bronstein, Newton, MA (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/756,209

(22) Filed: Jan. 9, 2001

(51) Int. Cl. G01N 21/76

(52) U.S. Cl. 436/172; 436/164; 422/52; 422/61; 435/4; 435/19; 435/21; 435/7.72; 435/29; 435/39; 435/810

(57) ABSTRACT

Chemiluminescent endogenous enzyme assays which provide for the rapid, simple, and sensitive quantitation of cells directly in microwell cultures by the measurement of endogenous enzyme activity. These endogenous enzyme assays provide homogeneous chemiluminescent formats for measuring cell proliferation, growth inhibition, cell adhesion, cell migration, and cell number quantitation and normalization. Methods and kits employing such assays are also provided.

### BACKGROUND OF THE INVENTION

1. Field of the Invention

This invention relates to endogenous enzyme assays designed for the rapid, simple, and sensitive quantitation of cells directly in microwell cultures by measurement of the enzyme activity of an endogenous enzyme. In particular, the assays provide homogeneous chemiluminescent assays to measure cell proliferation, growth inhibition, cell adhesion, cell migration, and cell number quantitation and normalization. Additionally, this invention pertains to methods and kits employing such assays.

2. Background of the Prior Art

A wide variety of assays exist which use visually detectable means to determine the presence or concentration of a particular substance in a sample. Colorimetric, fluorescent, and radioisotopic detection methods are traditional methods of optical detection. Recently, however, chemiluminescent assays for the detection of the presence or concentration of an analyte in a sample, generally a biological sample, have received increasing attention as a fast, sensitive, and easily read method of conducting biological assays. In such assays, a chemiluminescent compound is used as a detector molecule, which chemiluminesces in response to the presence or absence of the suspected analyte.

A wide variety of chemiluminescent compounds have been identified for use as detector molecules. One class of compounds of particular interest is 1,2-dioxetanes. The enzymatic cleavage of each chemiluminescent 1,2-dioxetane substrate produces a destabilized dioxetane anion, which fragments and emits light. Chemiluminescent detection with 1,2-dioxetanes is extremely sensitive as a result of low background luminescence coupled with high intensity. Enzyme-triggered decomposition allows for high sensitivity because one enzyme molecule can cause many dioxetane molecules to luminesce, thereby creating an amplification effect. Further, because dioxetane decomposition serves as the excitation energy source for the fluorescent chromophore present in the dioxetane, an external excitation source such as light is not necessary. Finally, because the dioxetane molecules are already in the proper oxidation state for decomposition, it is not necessary to add external oxidants, e.g., H₂O₂ or O₂ as in some other luminescent assays.

A wide variety of reporter gene assays are used in both biomedical and pharmaceutical research for the study of gene regulation and identification of cellular factors and chemical compounds that affect gene expression. Highly sensitive chemiluminescent detection of reporter enzymes has been achieved with 1,2-dioxetane substrates in assay formats that are amenable for use in both research-scale and automatable, high throughput pharmaceutical screening platforms. 1,2-Dioxetane substrates have been used extensively with both mammalian cells and extracts and yeast extracts and cells for reporter enzyme quantitation. Galacton®, Galacton-Plus® and Galacton-Star® are used for quantitation of β-galactosidase reporter enzyme activity for gene expression analysis in Saccharomyces, Schizosaccharomyces and Candida yeast extracts, including applications such as identification of RNA-binding proteins with a three hybrid system, the study of protein:protein interactions using a two-hybrid system, and the identification of DNA-protein interactions using a one-hybrid system. Galacton®, Galacton-Plus®, Galacton-Star®, and CSPD® substrates have been used quite extensively for quantitation of β-galactosidase and placental alkaline phosphatase reporter enzymes in mammalian cells, primarily for gene regulation, but also to study protein:protein interactions and in an assay for cell fusion.

Although reporter enzyme expression is useful for measuring gene regulation, it is desirable to have a mechanism to measure cell proliferation, cell adhesion, growth inhibition, cell migration, and cell number quantitation and normalization. Reporter enzymes may have limited usefulness for performing these measurements because the promoter used for controlling such a reporter gene must act independently of exogenous compounds or cell manipulation. One skilled in the art would need a gene construct that is expressed at a constant level by the cell regardless of what is added to the test cells.

Techniques for quantitating cell number to normalize or to measure cell proliferation, growth inhibition, cell adhesion or cytotoxic effects are presently known and include various methods for measurement of cellular enzyme activities, vital dye staining, measurement of ATP levels, and cellular respiration. Measurement of endogenous cellular enzyme activities by direct substrate cleavage, including esterases and acid phosphatases is used for several cell quantitation methods. The measurement of both reporter enzyme and endogenous cellular enzyme activity provides assays for normalization of reporter enzyme activity to cellular protein, or potentially enables simultaneous quantitation of the reporter activity and cell proliferation, growth inhibition, cell adhesion, cell migration, and cell number quantitation and normalization.

The present inventors have developed endogenous enzyme assays which are performed on cells directly in microwell cultures, in the presence of culture medium, that can provide quantitation of cell proliferation, growth inhibition, cell adhesion, cell migration, and cell number quantitation and normalization. These assays can also be used in conjunction with reporter gene assays as a control to monitor cell number and growth, and can potentially be coupled with luminescent reporter gene assays in a dual read-out format from a single well. Multiple enzyme assays are described in U.S. patent application Ser. No. 09/459,982, which is incorporated herein by reference.

### SUMMARY OF THE INVENTION

It is an object of the present invention to provide assays for the quantification of cells directly in microwell cultures or aliquots of a sample by the measurement of endogenous enzyme activity.

It is another object of the present invention to provide endogenous enzyme assays designed for the rapid, simple, and sensitive quantification of cells.

It is yet another object of the present invention to provide endogenous enzyme assays that utilize chemiluminescent 1,2-dioxetane substrates. The use of 1,2-dioxetane substrates provides sensitive, versatile, and facile chemiluminescent assay systems for the quantification of cells.

It is a further object of the present invention to provide a method for the quantification of cells directly in microwell cultures or aliquots of a sample.

It is yet another object of the present invention to provide kits employing the endogenous enzyme assays of the present invention.

It is an advantage of the present invention that the luminescent assays of the present invention can be coupled with luminescent reporter assays in dual read-out assays.

### BRIEF DESCRIPTION OF THE FIGURES

FIGS. 1A and 1B provide graphical illustration of the detection range of the Quant-Screen™ Yeast Assay in both rich and minimal yeast growth media and for two different types of yeast in 96-well microplates.

FIG. 2 provides graphical illustration of the detection range of the Quant-Screen™ Yeast Assay in both 96- and 384-well microplates.

FIGS. 3A and 3B provide graphical illustration of the kinetics of the Quant-Screen™ Yeast Assay in 96-well microplates.

FIG. 4 provides graphical illustration of leucine-dependent growth and the correlation of the Quant-Screen™ Yeast Assay to O.D. measurement and colony forming units.

FIG. 5 provides graphical illustration of yeast growth inhibition by actinomycin D treatment and the Quant-Screen™ Yeast Assay.

FIGS. 6A and 6B provide graphical illustration of the detection range and sensitivity of the Quant-Screen™ Mammalian Assay in the presence and absence of phenol red pH indicator in 96-well microplates.

FIGS. 7A and 7B provide graphical illustration of the sensitivity of the Quant-Screen™ Mammalian Assay in 96- and 384-well microplates.

FIG. 8 provides graphical illustration of the sensitivity of the Quant-Screen™ Mammalian Assay in 96-well microplates.

FIGS. 9A and 9B provide graphical illustration of the detection range and sensitivity of the Quant-Screen™ Mammalian Assay in the presence and absence of serum in 96-well microplates.

FIGS. 10A and 10B provide graphical illustration of the kinetics of the Quant-Screen™ Mammalian Assay with adherent NIH/3T3 cells (A) and suspension K562 cells (B) in 96-well microplates.

FIG. 11 provides graphical illustration of growth stimulation with calf serum and the correlation of the Quant-Screen™ Mammalian Assay with the Alamar Blue™ method.

FIG. 12 provides graphical illustration of growth inhibition with staurosporine and the correlation of the Quant-Screen™ Mammalian Assay with the Alamar Blue™ method.

### DETAILED DESCRIPTION OF THE INVENTION

The above objects are met by chemiluminescent enzyme assays which provide for rapid, simple, and sensitive quantitation of cells directly in microwell cultures by the measurement of endogenous enzyme activity. These endogenous enzyme assays provide homogeneous chemiluminescent formats for measuring cell proliferation, growth inhibition, cell adhesion, cell migration, and cell number quantitation and normalization.

The endogenous enzyme assays of the present invention comprise two main embodiments, namely, a non-mammalian cell endogenous assay and a mammalian cell endogenous assay.

In the first main embodiment of the present invention, the assay quantitates an endogenous enzyme in a non-mammalian cell. In this assay, a 1,2-dioxetane substrate specific for the endogenous enzyme is diluted with a reaction buffer diluent containing cell lysis components and an enhancer (i.e., a molecule which enhances the light signal produced by the degradation of the dioxetane substrate by the endogenous enzyme) to form a reaction buffer. The reaction buffer is added directly to microwells containing cultured cells. The endogenous enzyme causes the 1,2-dioxetane to decompose and luminesce. The luminescence can be measured by a luminometer, a scintillation counter, with a microplate imaging system such as the Tropix NorthStar™ workstation, or by other methods apparent to one of ordinary skill in the art. It is preferable to use a dedicated luminometer to measure the light emission from the microwells. The linear range of detection may vary according to cell type.

In a preferred embodiment, the non-mammalian cell is yeast, the endogenous enzyme is alkaline phosphatase, and the 1,2-dioxetane is CDP-Star™. Alkaline phosphatase activity is found in many yeasts, including Saccharomyces, Schizosaccharomyces, Neurospora, Aspergillus, Candida, and Coprinus. The gene expression level of alkaline phosphatase is regulated only by the availability of inorganic phosphate in the growth medium, which should be identical in all samples. The non-mammalian cell endogenous enzyme assay of the present invention can be performed with cells in both rich and minimal growth media. With this assay, a range of detection of at least three orders of magnitude of cell concentration can be achieved.

Examples of enhancer molecules for use in the present invention include certain water soluble naturally occurring and synthetic substances, generally macromolecular in nature, that enhance the chemiluminescent signal intensity. These substances include water soluble globular proteins that contain hydrophobic regions such as mammalian serum albumins (e.g., bovine serum albumin (BSA) and human serum albumin (HSA)), or water soluble polymeric quaternary onium salts such as polyvinylbenzyltrimethyl ammonium chloride (TMQ), poly(vinylbenzyltributyl ammonium chloride) (TBQ) (Sapphire-II™), polyvinylbenzylbenzyldimethyl ammonium chloride (BDMQ) (Sapphire™), polyvinylbenzyltributyl phosphonium chloride, BDMQ plus sodium fluorescein (Emerald™), TBQ plus sodium fluorescein (Emerald-II™). These enhancer molecules increase the chemiluminescent signal intensity produced by the decomposition of enzymatically cleavable 1,2-dioxetanes in aqueous solutions and are available from Applied Biosystems, Bedford, Mass.

The enhancer molecules improve the chemiluminescent signal of the dioxetane, apparently by providing a hydrophobic environment in which the dioxetane is sequestered. In aqueous solution, as biological assays are typically conducted, proton transfer events result in a 1000-fold decrease in chemiluminescence intensity as compared with that obtained in organic solvent environments. The water-soluble polymeric enhancers provide approximately 100-fold enhancement of light emission in aqueous reactions. Although not wishing to be bound by theory, the enhancer molecules apparently exclude water from the microenvironment in which the dioxetane molecules, or at least the excited state emitter species reside, thereby resulting in enhanced chemiluminescence. Other effects associated with the enhancer-dioxetane interaction could also contribute to the chemiluminescent enhancement.

By virtue of the presence of effective amounts of an enhancer substance or substances, the intensity of the light emitted in an aqueous medium is increased significantly as compared to the intensity of light emitted in the absence of such enhancers. These compounds enhance the intensity of the chemiluminescent signal from 1,2-dioxetanes by a factor of at least 10- to 100-fold.

In a second embodiment of the present invention, the assay quantitates an endogenous enzyme in a mammalian cell. In this assay, a 1,2-dioxetane substrate specific for the endogenous enzyme is diluted with a reaction buffer diluent containing cell lysis components to form a reaction buffer. The reaction buffer is added directly to microwells containing cell culture in the presence of culture media. The cell culture is then incubated. Following incubation, an accelerator containing a luminescence enhancer may be added to the microwells. Luminescence can be measured by a luminometer, scintillation counter, with a microplate imaging system such as the Tropix NorthStar™ workstation, or by other methods apparent to one of ordinary skill in the art. It should be noted that the assay can be performed in the presence or absence of phenol red.

In a preferred embodiment, the endogenous enzyme is β-glucosidase, the 1,2-dioxetane is Glucon™, and an accelerator solution is used.

In the assays of the present invention, white microplates are recommended for optimal sensitivity. Clear-bottom white plates can be utilized to allow microscopic examination of cell cultures. Additionally, white backing sheets may be applied to the plate bottom prior to measuring the chemiluminescent signal. Because the white backing reflects light toward the detector and eliminates the potential absorption of light by the black plate platform, the absolute signal obtained will be higher (e.g., approximately 2-fold higher). Generally, 96- or higher density microplate formats are used.

The assays of the present invention rely on the high sensitivity of 1,2-dioxetanes. The dioxetanes, developed by the assignee herein, Tropix, Inc., are the subject of a wide variety of U.S. patents. Generally, dioxetanes are molecules that have a 4-membered ring in which two of the members are adjacent oxygen atoms. Dioxetanes can be thermally, chemically, or photochemically decomposed to form carbonyl products, e.g., esters, ketones, or aldehydes. The decomposition releases energy in the form of light (i.e., luminescence). Specifically, the dioxetane substrates each contain an enzyme-cleavable group that can be cleaved by a corresponding enzyme. When cleaved, a negatively charged group (e.g., an oxygen anion) is left bonded to the dioxetane. This dioxetane anion destabilizes the dioxetane which then decomposes to form a luminescent substance that produces light. The light signal is detected as an indication of the presence and the amount of the enzyme. Thus, by measuring the intensity of the luminescence signal in the presence of excess substrate, the concentration of the corresponding enzyme can be determined.

In the present invention, substrates for the endogenous enzymes comprise any luminescent substrate specific for that endogenous enzyme that is capable of producing a light signal. Preferably, the substrates for each enzyme are a dioxetane that contains a substituted or unsubstituted adamantyl group, a Y group which may be substituted or unsubstituted, and an enzyme cleavable group.

Preferably, the dioxetane-containing substrate has general formula I:

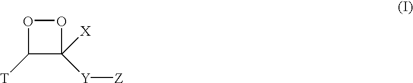

wherein T is a substituted or unsubstituted cycloalkyl ring having between 6 and 12 carbon atoms, inclusive, in the ring or a polycycloalkyl group having 2 or more fused rings, each ring independently having between 5 and 12 carbon atoms, inclusive, wherein T is bonded to the 4-membered dioxetane ring by a spiro linkage (e.g., a chloroadamantyl or an adamantyl group); Y is a fluorescent chromophore; X is hydrogen, a straight or branched chain alkyl or heteroalkyl group having between 1 and 7 carbon atoms, inclusive, (e.g., methoxy, trifluoromethoxy, hydroxyethyl, trifluoroethoxy or hydroxypropyl), an aryl group having at least 1 ring (e.g., phenyl), a heteroaryl group having at least 1 ring (e.g., pyrrolyl or pyrazolyl), a heteroalkyl group having between 2 and 7 carbon atoms, inclusive, in the ring, (e.g., dioxetane), an aralkyl group having at least 1 ring (e.g., benzyl), an alkaryl group having at least 1 ring (e.g., tolyl), or an enzyme-cleavable group (i.e., a group having a moiety which can be cleaved by an enzyme to yield an electron-rich group bonded to the dioxetane, e.g., phosphate, where a phosphorus-oxygen bond can be cleaved by an enzyme, e.g., acid phosphatase or alkaline phosphatase, to yield a negatively charged oxygen bonded to the dioxetane or OR); and Z is hydrogen, hydroxyl, or an enzyme-cleavable group (as defined above), provided that at least one of X or Z must be an enzyme-cleavable group and that the negatively charged group contains the group Y.

Group Z is an enzyme cleavable group. Upon contact with an enzyme, group Z is cleaved off, thereby yielding an electron-rich moiety bonded to the chromophore Y. This electron-rich moiety initiates the decomposition of the dioxetane into two individual carbonyl containing compounds, e.g., into a ketone or an ester and an aldehyde if group X is hydrogen. Examples of electron-rich moieties include oxygen, sulfur, and amine or amino anions. The most preferred moiety is an oxygen anion. Examples of enzymes that cleave Z groups include alkaline and acid phosphatases, esterases, decarboxylases, phospholipase D, β-xylosidase, β-D-fucosidase, thioglucosidase, β-D-galactosidase, α-D-galactosidase, α-D-glucosidase, β-D-glucosidase, β-D-glucuronidase, α-D-mannosidase, β-D-mannosidase, β-D-fructofuranosidase, β-D-glucosiduronase, and trypsin.

Group Y is a fluorescent chromophore or fluorophore bonded to the enzyme-cleavable group Z. In general, it is desirable to use a chromophore which maximizes the quantum yield in order to increase sensitivity. Therefore, Y usually contains aromatic groups. Examples of suitable chromophores are further described in U.S. Pat. No. 4,978,614.

Y becomes luminescent upon the dioxetane decomposition caused by the enzyme cleaving of group Z. When Z is cleaved, an electron-rich moiety is formed which destabilizes the dioxetane, leading to its decomposition. This decomposition produces two individual carbonyl compounds, one of which contains group T, and the other of which contains groups X and Y. The energy released from the decomposition causes compounds containing the X and the Y groups to luminesce. Y preferably is phenyl or aryl.

The luminescent signal is detected as an indication of the activity of the endogenous enzyme. By measuring the intensity of luminescence, the activity of the endogenous enzyme can be determined. The enzyme activity correlates to the number of cells present.

Examples of preferred dioxetanes include 3-(4-methoxyspiro [1,2-dioxetane-3,2′-(5′-chloro) tricyclo [3.3.1.1^{3,7}]-decan]-4-yl-phenyl-β-D-galactopyranoside (Galacton®), 5-chloro -3-(methoxyspiro[1,2-dioxetane-3,2′-(5′chloro)tricyclo[3.3.1.1^{3,7}]decan]-4-yl-phenyl-β-D-galactopyranoside (Galacton-Plus®), disodium 6-(4-methoxyspiro-[1,2-dioxetane-3,2′-tricyclo[3.3.1.1^{3,7}]decan]-4-yl)-2-phenylbenzothiazolyl-4-phosphate, disodium 2-chloro-5-(4-methoxyspiro[1,2-dioxetane-3,2′-(5′-chloro)-tricyclo {3.3.1.1^{3,7}]decan]-4-yl)-1-phenyl phosphate (CDP-Star®), sodium 3-(4-methoxyspiro[1,2-dioxetane-3,2′-(5′-chloro)-tricyclo[3.3.1.1^{3,7}]decan]-4-yl)phenyl-β-D-glucuronate (Glucuron™), 3-(4-methoxyspiro[1,2-dioxetane-3,2′-(5′-chloro)-tricyclo[3.3.1.1^{3,7}]decan]-4-yl)phenyl-β-D-glucopyranoside (Glucon™), 2-chloro-5-(4-methoxyspiro[1,2-dioxetane-3,2′(5′-chloro)-tricyclo-[3.3.1.1^{3,7}]decan]-4-yl)phenyl)-β-D-galactopyranoside, (Galacton-Star®), disodium 3-(4-methoxyspiro[1,2-dioxetane-3,2′(5′-chloro)-tricyclo-[3.3.1.1^{3,7}]decan]-4-yl)phenyl phosphate (CSPD®), disodium 3-chloro-5-(4-methoxyspiro[1,2-dioxetane-3,2′(5′-chloro)-tricyclo-[3.3.1.1^{3,7}]decan]-4-yl)-l-phenyl phosphate (CDP®), disodium 3-(4-methoxyspiro[1,2-dioxetane-3,2′-tricyclo[3.3.1.1^{3,7}]decan]-4-yl)phenyl phosphate (AMPPD®), and disodium 2-chloro-5-(4-methoxyspiro[1,2-dioxetane-3,2′-tricyclo[3.3.1.1^{3,7}]decan]-4-yl)-1-phenyl phosphate (ADP-Star®). These substrates are available from Applied Biosystems, Bedford, Mass.

Endogenous enzymes that are useful in the present invention comprise any endogenous enzyme that exhibits enzymatic activity and degrades a substrate to produce a light signal. Examples of useful endogenous enzymes include alkaline phosphatase, acid phosphatase, glucosidase, glucuronidase, galactosidase, proteases and esterases. Preferred endogenous enzymes are alkaline phosphatase, glucosidase, glucuronidase, and galactosidase. The most preferred endogenous enzymes are alkaline phosphatase and β-glucosidase.

When alkaline phosphatase is the endogenous enzyme, it is preferable that the substrate comprises a phosphate-containing dioxetane, such as 3-(2′-spiroadamantane)-4-methoxy-4-(3″-phosphoryloxy)phenyl-1,2-dioxetane, or disodium 3-(4-methoxyspiro[1,2-dioxetane-3,2′(5′-chloro)-tricyclo-[3.3.1.1^{3,7}]decan]-4-yl) phenyl phosphate, or disodium 2-chloro-5-(4-methoxyspiro[1,2-dioxetane-3,2′-(5′-chloro)-tricyclo[3.3.1.1^{3,7}]decan]-4-yl)-1-phenyl phosphate, or disodium 2-chloro-5-(4-methoxyspiro[1,2-dioxetane-3,2′-tricyclo[3.3.1.1^{3,7}]decan]-4-yl)-1-phenyl phosphate (AMPPD®, CSPD®, CDP-Star® and ADP-Star®, respectively).

In assays that use β-glucosidase as the endogenous enzyme, the substrate comprises a dioxetane containing β-glucosidase-cleavable groups such as a glucosidase, e.g., sodium 3-(4-methoxyspiro[1,2-dioxetane-3,2′-(5′-chloro)-tricyclo[3.3.1.1^{3,7}]decan]-4-yl)phenyl-β-D-glucuronate (Glucon™).

It may be desirable to measure the activity of more than one endogenous enzyme in a single aliquot of sample. The present invention can readily be used to make such measurements.

When measuring certain endogenous enzymes it may be necessary to further treat the cells. For example, when measuring endogenous enzymes that are present in the cell or serum in large amounts, the background level may be too high to produce an accurate reading. In such a case, it may be preferable to wash the cells prior to the assay. One of ordinary skill in the art can readily determine which endogenous enzymes will require a wash, and will be able to determine the appropriate wash solution.

As described above, the assays of the present invention measure the activity of endogenous enzymes, which correlates to the number of cells present in the sample. The assays of the present invention enable the normalization of cells in an assay by providing a measurement of cell number. Additionally, the assays enable the monitoring of cell proliferation and inhibition, which may be affected by the test conditions. For example, when certain compounds are added to the cells that produce a non-specific effect, e.g., growth factor, it is desirable to confirm that regular cell functions are occurring, as opposed to those that are controlling the reporter construct. The assays of the present invention enable that confirmation. Further, the cytotoxic effects of test conditions, i.e., potential drugs, changes in temperature or pH, etc., can be evaluated by the assays and methods according to the present invention. In addition, cytotoxicity can potentially be determined by measuring enzyme activity within cells as an indicator of viable cells present.

The present invention also provides kits for the quantification of cells by the measurement of endogenous activity. One such kit for the quantification of non-mammalian cells comprises a 1,2-dioxetane and a reaction buffer containing an enhancer and cell lysis reagent(s). A kit for the quantification of mammalian cells comprises a 1,2-dioxetane, a reaction buffer containing cell lysis reagent(s), and an accelerator.

The following examples are provided to illustrate the present invention and are not intended in any way to limit the scope of the invention.

### EXAMPLES

Examples 1 and 2 below were conducted using the following components:

Quant-Screen ™ Yeast Reaction Buffer:
100 mM AMP (2-amino-2-methyl-1-propanol), pH 9.5
10 mM MgCl₂
0.5 mM digitonin
5% glycerol
0.01% SDBS (sodium dodecylbenzenesulfonate)
20% Sapphire-II ™
1.1 mM CDP-Star ®

### Example 1

Basic Assay Protocol (Yeast Cells)

1) 96-Well Microplate

Serial dilutions of a yeast cell suspension prepared in culture media was placed in each well of a 96- well plate (100 μl/well). Next, 100 μl of reaction buffer containing the CDP-Star® substrate was added to each well. The light emission was then immediately measured in a luminometer (TR717®) (1 sec/well) or NorthStar® (60 sec/plate).

2) 384-Well Microplate

Serial dilutions of a yeast cell suspension was seeded into each well of a 384- well plate (25 μl/well). 25 μl of reaction buffer was then added to each microwell. Next, the plate was placed in a luminometer (TR717™) or NorthStar™. Light emission was then immediately measured at room temperature.

Results

The assay was performed directly in microplate wells containing yeast culture suspensions.

The assay was performed on both Saccharomyces cerevisiae and Schizosaccharomyces pombe yeast cells.

The assay was performed in both rich growth medium and minimum growth medium.

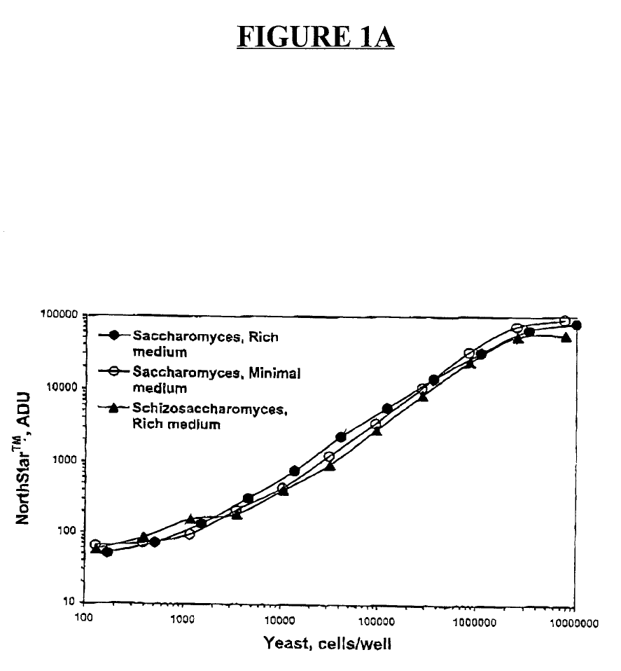

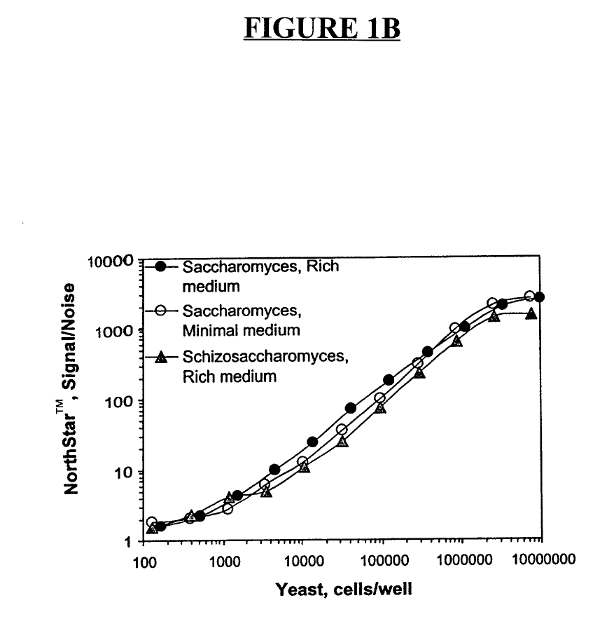

Saccharomyces cerevisiae strains INVSc1 and SFY526 were grown overnight at 30° C. in YPD (rich medium) and Synthetic Defined (SD) (minimum medium) respectively. FIGS. 1A and 1B show similar signal intensity, detection range, and sensitivity for both strains in both types of media.

Expression of phosphatase genes in yeast is known to be repressed by the presence of inorganic phosphate in the growth medium. However, at phosphate concentrations similar to those present in a minimal media, a significant decrease in the amount of alkaline phosphatase activity has not been observed.

The assay was performed in both 96- and 384-well microplate formats and the assay provides for a linear detection range of 2-3 orders of magnitude of cell concentration with each format.

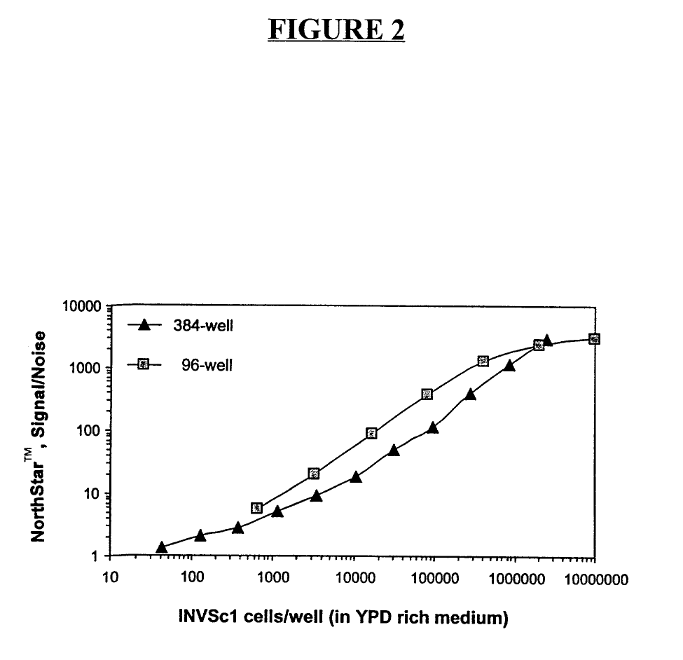

Serial dilutions of yeast culture (INVSc1) were seeded in 96- and 384- well microplates and light emission was measured by NorthStar™. FIG. 2 demonstrates both the detection range and sensitivity of the assay in 384-well plates.

For yeast Saccharomyces cerevisiae and Schizosaccharomyces pombe, the assay gave a detection range of at least 3 orders of magnitude of cell concentration in a 96-well and in a 384-well microplate. (See FIGS. 1 and 2).

The light emission lasts at least 60 minutes. Glow light emission is achieved, with maximum intensity reached approximately 40-60 minutes following reagent addition.

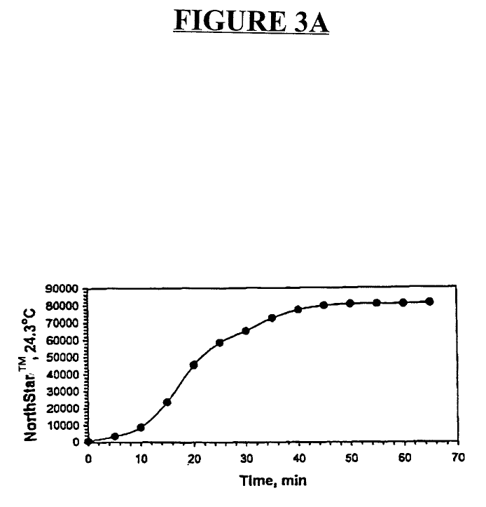

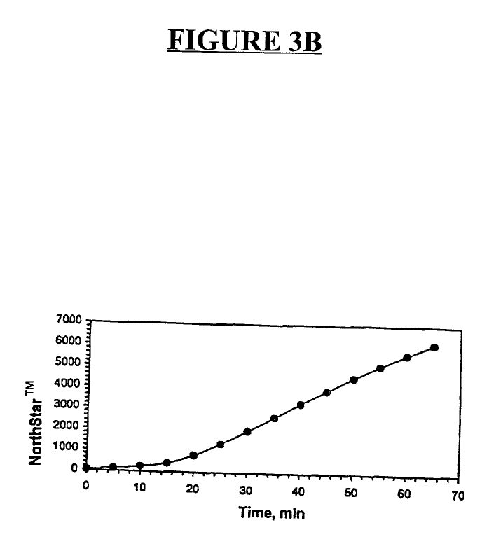

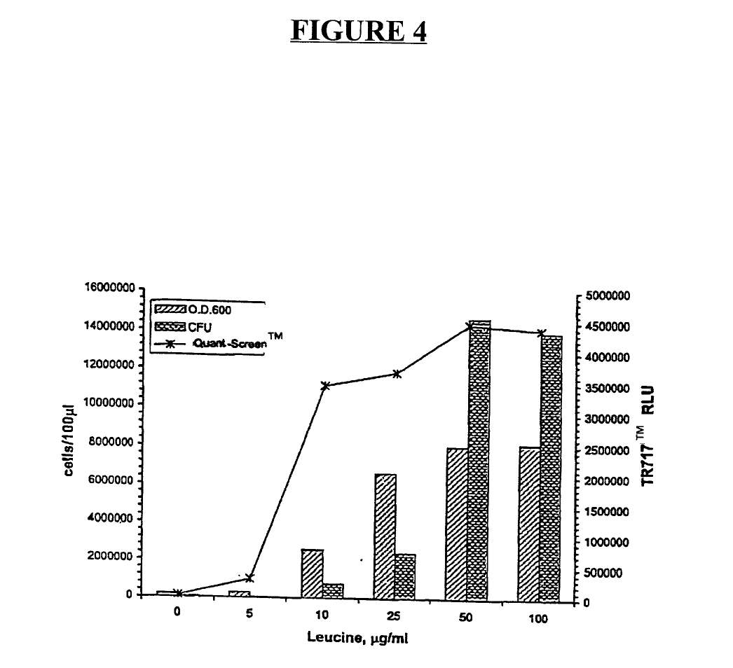

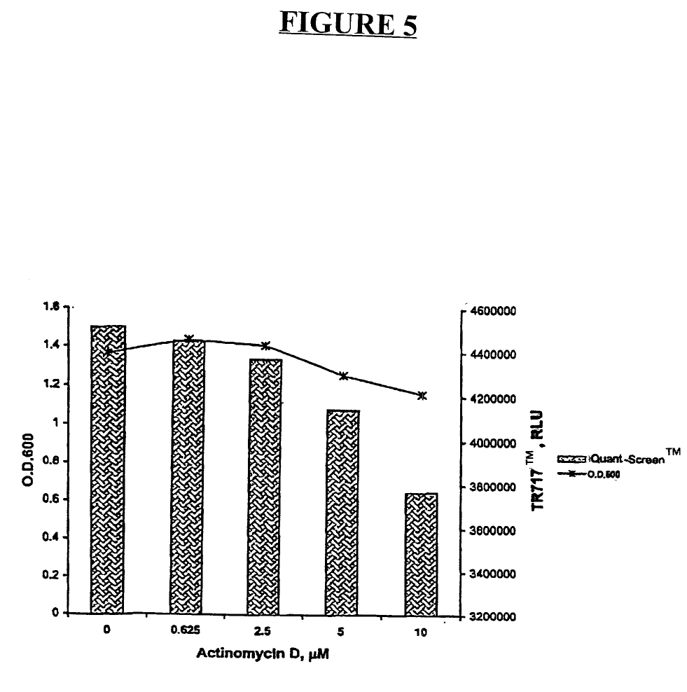

FIGS. 3A and 3B show the kinetics of the assay in a 96-well plate for two cell densities. FIG. 3A shows a density of 1×10⁷cells/well. FIG. 3B shows a density of 1.2×10⁵ cells/well. Both are Saccharomyces cerevisiae yeast cells grown in rich medium.

Typical cell density for yeast cell cultures is 1,000-1,000,000 cells/well in 100 μl for 96-well plates, and 500 to 40,000 cells/well in 25 μl for 384-well plates.

Conclusion

The Quant-Screen™ Yeast Assay, which measures endogenous alkaline phosphatase activity as a marker of cell proliferation or growth inhibition, is able to perform in different yeast species, in a rich medium as well as in a minimum medium, and in both a 96- and 384-well plate format. The light signal following reagent addition glows for at least 60 minutes, and the assay can detect a broad range of cell concentrations.

### Example 2

Assay Procedure (Yeast Cells)

1) Growth Stimulation Experiment

An equivalent aliquot of yeast cell suspension (INVSc1) were inoculated into tubes with 2 ml of minimum medium containing various concentrations of leucine and were grown overnight at 30° C. with shaking. The overnight cultures were then measured by a spectrophotometer at 600 nm to estimate cell density. Next, each of the overnight cultures was transferred (100 μl/well) into a 96-well microplate in triplicate. An equal volume of reaction buffer was added. The plate was placed in TR717™ (a luminometer) to measure total light emission.

100 or 200 μl of cells from each overnight culture were plated on a YPD agar plate in order to obtain colony-forning units.

2) Growth Inhibition Experiment

100 μof log phase growing yeast cells, INVSc1, were inoculated into tubes with 1 ml of YPD medium containing different concentrations of actinomycin D, a protein synthesis inhibitor. The cultures were grown at 30° C. with shaking for 6 hours. The cultures were measured for OD₆₀₀ in a spectrophotometer. Next, the cells were transferred (100 μl/well) in triplicate in a 96-well microplate. The assay was performed as in the Growth Stimulation Experiment set forth above.

Results

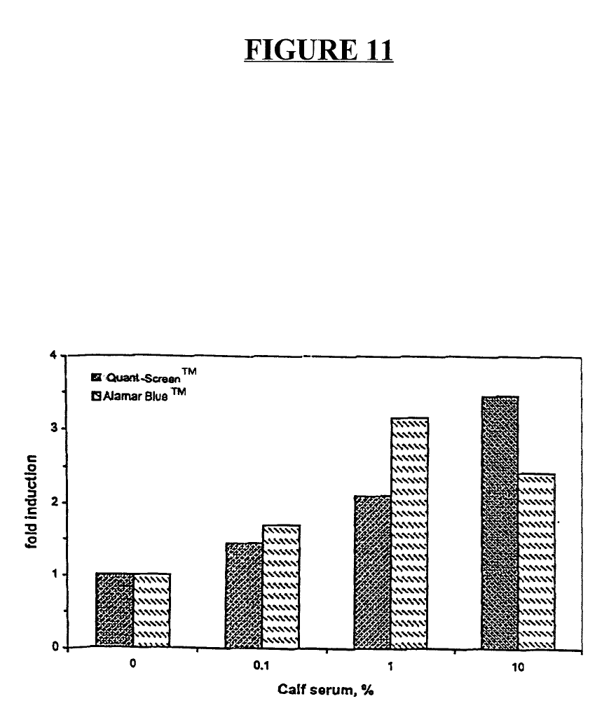

FIG. 11 shows the correlation of the assay to O.D. measurement and colony-forming units. The results indicate that the assay is comparable to other experimental methods.

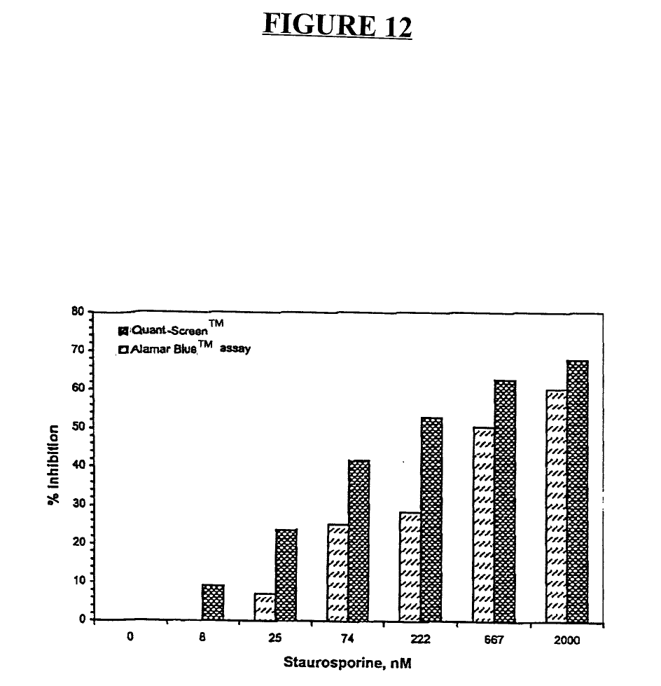

For the growth inhibition experiment, results from actinomycin D treatment demonstrated a correlation of the assay to O.D. measurement. (See FIG. 12). The signal intensity as well as the O.D. measurement declined with increasing concentrations of chemical compounds.

Conclusion

The Quant-Screen™ Yeast Assay is one method to measure yeast cell numbers. Additionally, it is comparable to O.D. measurement and colony counting. Further, the assay is simple, accurate, and can be adapted to high throughput screening.

### Example 3

The assay was conducted using the following components:

Quant-Screen ™ Mammalian Reaction Buffer:

| | |
|---|---|
| | 150 mM Sodium Phosphate, pH 5.5 |
| | 30 mM EDTA |
| | 0.3% Triton X-100 |
| | 0.2% SDBS (sodium dodecylbenzenesulfonate) |
| | 0.6 mM Glucon ™ |
| Accelerator: | 1 M Diethanolamine, pH 9.5 |
| | 30% Sapphire-II ™ |

Basic Assay Protocol (Mammalian Cells)

Serial dilutions of a suspension of mammalian cells (100 μl/well) were seeded in a 96-well microplate and incubated for at least four hours. Next, 50 μl of reaction buffer containing the Glucon™ substrate was added to each well. Following a 30 minute incubation at room temperature, 50 μl of the accelerator was added. The plate was then placed in a luminometer and light emission was measured with the TR717™ (1 sec/well) or NorthStarm™ (60 sec/plate).

25 μl of cell culture was placed in each well of a 384-well microplate. Next, 12.5 μl of the reaction buffer containing the dioxetane substrate was added. After a 30 minute incubation period at room temperature, 12.5 μl of the accelerator was added. The light emission was then measured by a luminometer, TR717™ (1 sec/well) or NorthStarm™ (120 sec/plate).

Results

The assay was performed directly in microplate wells containing culture medium and cells.

The assay was performed directly in microplate wells containing culture medium and cells according to the Basic Assay Protocol. All data collected was generated directly in the cell culture plate, in the presence of culture media.

The assay was performed in the presence/absence of phenol red pH indicator dye.

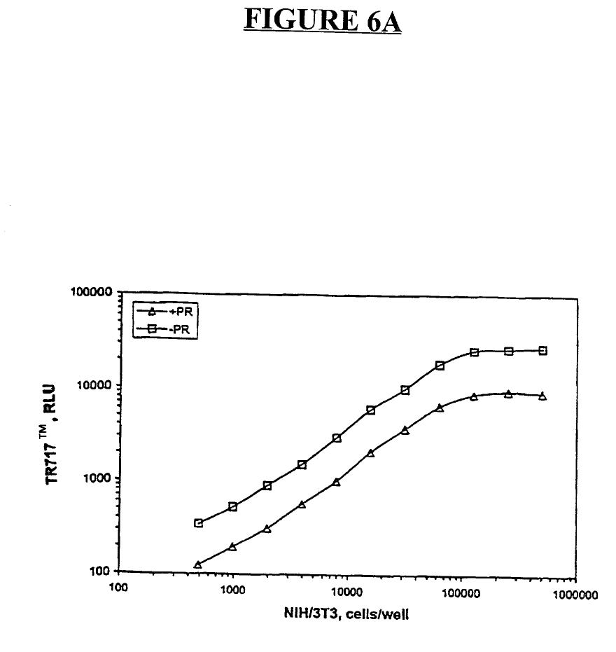

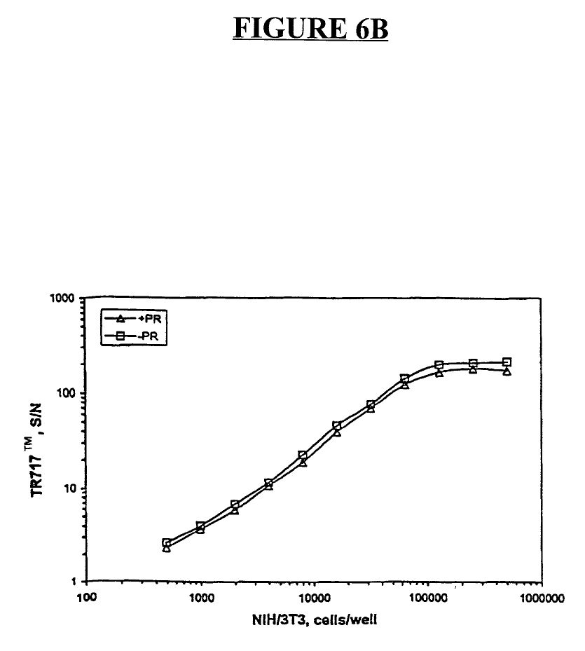

In the presence of phenol red, an approximately 3 fold reduction in light intensity was observed. (See FIG. 6A). However, the sensitivity of assay detection in the presence and absence of phenol red remained the same. (See FIG. 6B).

The assay was performed in both 96- and 384-well microplate formats.

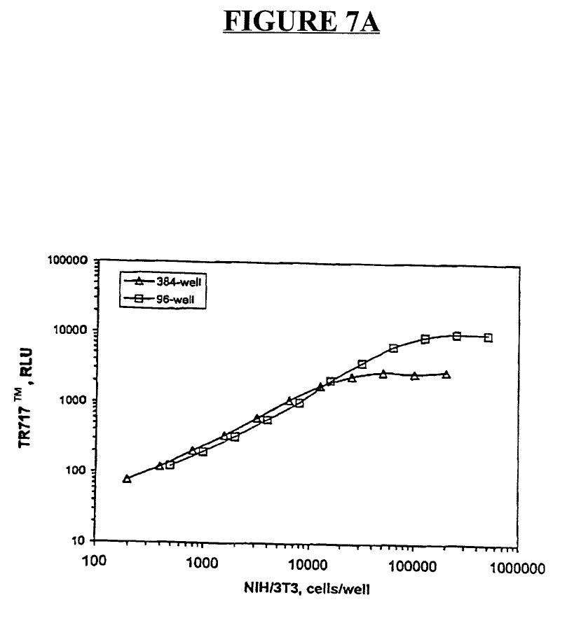

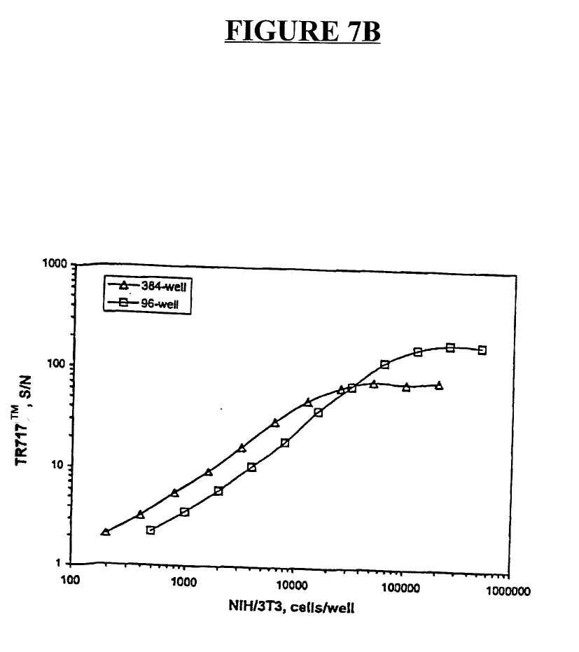

The assay was performed in 96- and 384-well microplate formats. The assay has similar or higher sensitivity in a 384-well plate than that in a 96-well plate (see FIGS. 7A and 7B), with a linear range of detection that covers the appropriate range of cell densities for each format.

The assay was performed with adherent and suspension cell lines.

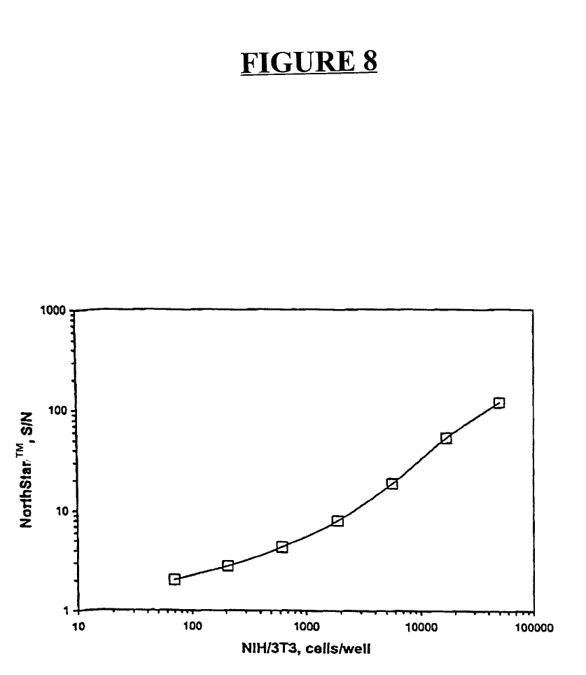

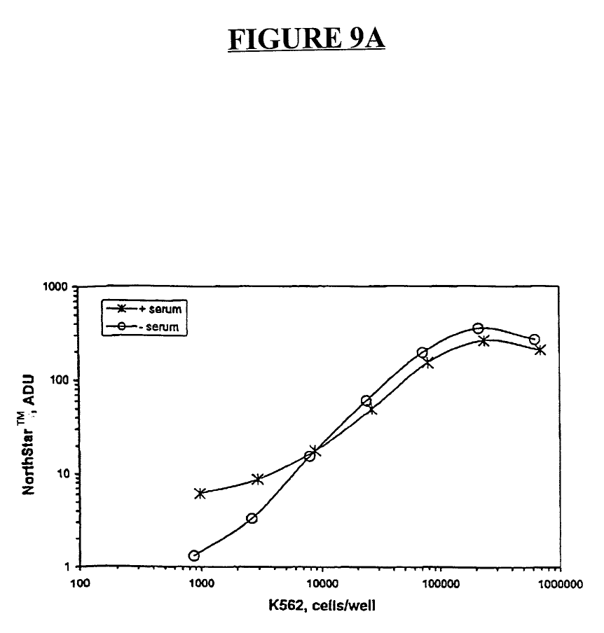

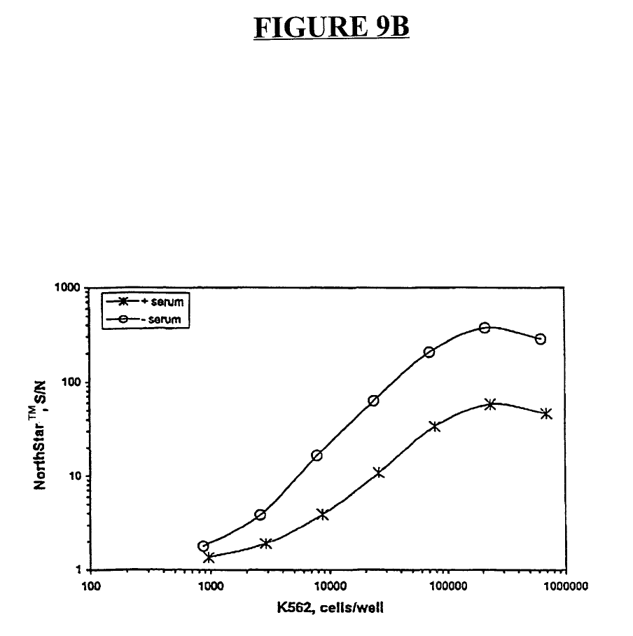

The assay has been demonstrated with an adherent cell line, NIH/3T3, and a suspension cell line, K562. As shown in FIG. 8 (adherent cell line) and FIGS. 9A and 9B (suspension cell line), the sensitivity of the assay in both cell types gave a linear range of detection over two orders of magnitude of cell concentration.

The light emission lasts about 60 minutes.

Light emission was maintained for approximately one hour, with a maximum intensity at about 20-30 minutes after the addition of the accelerator.

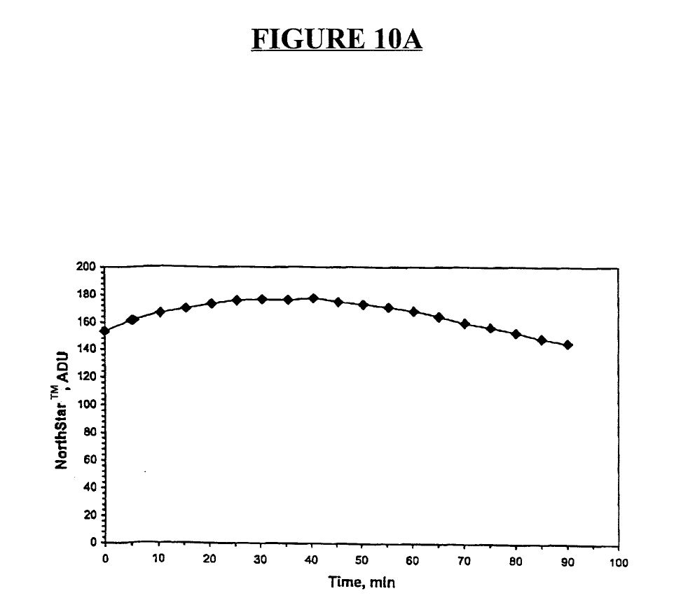

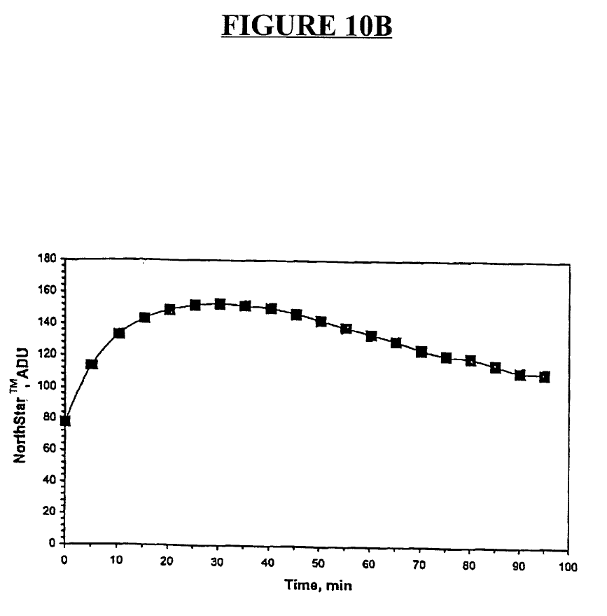

FIGS. 10A and 10B demonstrate the kinetics of the assay obtained from NIH/3T3 and K562 cells. As shown, nearly constant signal intensity lasted approximately 60 minutes after the addition of the accelerator. Light intensity typically reached maximum intensity 20-30 minutes after the accelerator was added. FIG. 10A shows 5×10⁴ cells/well (NE/3T3 cells) cultured in a 96-well microplate in DMEM/10% calf serum/with phenol red. FIG. 10B shows 7.8×10⁴ cells/well (K562 cells) cultured in a 96-well microplate in RPM1/10% FBS/with phenol red.

A linear detection range of two orders of magnitude of cell concentration was achieved with any cell line.

FIGS. 9A and 9B show a linear detection range of 2 orders of magnitude of cell concentration of NIH/3T3 and K562 cells in media with or without serum.

Conclusion

The kinetics of the assay is steady-glow for approximately one hour after the addition of the accelerator. The detection limit for cell concentration at the low end is around 100-200 cells in medium for adherent cells, and 1000 to 2000 cells in medium for suspension cells. The time needed to reach the peak signal is approximately 20-30 minutes at approximately 25° C. Similar assay performances were achieved for both 96- and 384-well formats.

### Example 4

The assay was conducted using the following components:

Quant-Screen ™ Mammalian Reaction Buffer:

| | |
|---|---|
| | 150 mM Sodium Phosphate, pH 5.5 |
| | 30 mM EDTA |
| | 0.3% Triton X-100 |
| | 0.2% SDBS (sodium dodecylbenzenesulfonate) |
| | 0.6 mM Glucon ™ |
| Accelerator: | 1 M Diethanolamine, pH 9.5 |
| | 30% Sapphire-II ™ |

Assay Procedure (Mammalian Cells)

1) Growth Stimulation Experiment

NIH/3T3 Cells (5,000 cells/100 μl) were seeded in each microwell and grown in DMEM containing 10% calf serum at 37° C. with 10% CO₂ for 22 hours. Then, the cells were grown for 53 hours in a medium containing different amounts of calf serum. Next, the cells were washed once with PBS and changed to full medium. 50 μl of reaction buffer containing the Glucon™ substrate was added to each well. Following a 30 minute incubation at room temperature, 50 μl the accelerator was added. The plate was then placed in a luminometer to measure light emission.

After the cells were manipulated as described above for either growth stimulation or growth inhibition, 10μl of Alamar Blue™ reagent was added to each microwell and continually incubated at 37° C. for 4 hours. The plate was then placed in a fluorescence reader, e.g., FLUOstar Galaxy (BMG, Inc.), to measure the fluorescence emission (excitation at 560 nm, emission at 590 nm).

2) Growth Inhibition Experiment

NIH/3T3 Cells (1×10⁴ cells/100 μl) were seeded in each microwell and grown in full medium for 24 hours. The cells were then incubated for 26 hours in full medium containing various concentrations of staurosporine. The assay was performed as set forth above in the Growth Stimulation Experiment.

Results

FIG. 11 shows a nearly linear correlation between signal intensity (representative of cell numbers) and concentrations of calf serum in the medium. A similar result was obtained from the Alamar Blue™ assay, a commercial fluorescence-based assay, which is based on the detection of metabolic activity.

Another comparison between the present invention and the Alamar Blue™ assay was performed in a growth inhibition experiment. In this experiment, cells were grown in a full medium for 24 hours and were then incubated with staurosporine for 26 hours before the assay was performed. FIG. 12 shows a correlation of growth inhibition to the concentration of staurosporine.

Conclusion

The assay is capable of detecting cell proliferation and chemical compound toxicity during cell growth. The procedure and sensitivity of the assay is comparable to commercially available assays, such as the Alamar Blue™ assay.

The invention has been described generically and in detail with particular references to the preferred embodiments thereof and with reference to specific examples. However, it will be appreciated that modifications and improvements within the spirit and scope of this invention may be made by those ordinarily skilled in the art upon considering the present disclosure. Unless excluded by the recitations of the claims set forth below, these variations remain within the scope of the invention.

1. An assay for the quantitation of cells in a microwell culture or an aliquot of a sample comprising:
quantifying the activity of an endogenous enzyme in an aliquot of a sample by measuring any luminescence produced by the degradation of an enzyme substrate specific for said endogenous enzyme by said endogenous enzyme,
wherein said luminescence is as an indication of the activity of said endogenous enzyme, and
wherein said enzyme activity correlates to the number of cells present.

2. The assay of claim 1, wherein said endogenous enzyme is selected from the group consisting of alkaline phosphatase, acid phosphatase, glucosidase, glucuronidase, galactosidase, proteases and esterases.

3. The assay of claim 1, wherein said enzyme substrate is selected from the group consisting of 3-(2′-spiroadamantane)-4-methoxy-4-(3″-phosphoryloxy)phenyl-1,2-dioxetane, disodium salt, disodium 3-(4-methoxyspiro[1,2-dioxetane-3,2′(5′-chloro)-tricyclo-[3.3.1.1^{3,7}]decan]-4-yl)phenyl phosphate, disodium 2-chloro-5-(4-methoxyspiro[1,2-dioxetane-3,2′-(5′-chloro)-tricyclo[3.3.1.1^{3,7}]decan]-4-yl)-1-phenyl phosphate, and disodium 2-chloro-5-(4-methoxyspiro[1,2-dioxetane-3,2′-tricyclo[3.3.1.1^{3,7}]decan]-4-yl)-1-phenyl phosphate.

4. The assay of claim 1, wherein said enzyme substrate is a 1,2-dioxetane.

5. The assay of claim 4, wherein said 1,2-dioxetane has the formula I: 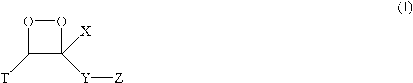
wherein T is a substituted or unsubstituted cycloalkyl ring having between 6 and 12 carbon atoms or a polycycloalkyl group bonded to the 4-membered dioxetane ring by a Spiro linkage; Y is a fluorescent chromophore; X is hydrogen, a straight chain or branched chain alkyl or heteroalkyl group, an aryl group, a heteroaryl group, a heteroalkyl group, an aralkyl group, an alkaryl group, or an enzyme-cleavable group; Z is hydrogen, hydroxyl, or an enzyme-cleavable group;
provided that at least one of X or Z must be an enzyme-cleavable group;
wherein said enzyme-cleavable group is cleaved by said endogenous enzyme to thereby form a negatively charged group bonded to the dioxetane which decomposes to form a luminescing substance; and
wherein said negatively charged group includes the group Y.

6. The assay of claim 1, wherein said cells are yeast cells and are in a rich growth medium.

7. The assay of claim 1, wherein said cells are yeast cells and are in a minimal growth medium.

8. The assay of claim 1, wherein said cells are mammalian cells.

9. The assay of claim 1, wherein said cells are adherent or suspension cells.

10. The assay of claim 1, wherein said assay is performed with 96- or higher density microplate fornat.

11. A method for the quantitation of cells in a microwell cell culture or an aliquot of a sample comprising:
admixing cell lysis components, an enzyme substrate, and an enhancer to form a reaction buffer,
adding said reaction buffer directly to said microwell cell culture or aliquot of a sample, and
measuring any luminescence generated as a result of said addition;
wherein said luminescence is as an indication of the activity of the corresponding endogenous enzyme, and
wherein said activity correlates to the number of cells present.

12. The method of claim 11, wherein said cells are yeast cells.

13. The method of claim 11, wherein said enzyme substrate is a 1,2-dioxetane.

14. The method of claim 13, wherein said 1,2-dioxetane has the formula I: 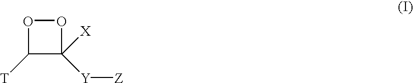
wherein T is a substituted or unsubstituted cycloalkyl ring having between 6 and 12 carbon atoms or a polycycloalkyl group bonded to the 4-membered dioxetane ring by a spiro linkage; Y is a fluorescent chromophore; X is hydrogen, a straight chain or branched chain alkyl or heteroalkyl group, an aryl group, a heteroaryl group, a heteroalkyl group, an aralkyl group, an alkaryl group, or an enzyme-cleavable group; Z is hydrogen, hydroxyl, or an enzyme-cleavable group;
provided that at least one of X or Z must be an enzyme-cleavable group;
wherein said enzyme-cleavable group is cleaved by said endogenous enzyme to thereby form a negatively charged group bonded to the dioxetane which decomposes to form a luminescing substance; and
wherein said negatively charged group includes the group Y.

15. The method of claim 11, wherein said endogenous enzyme is alkaline phosphatase.

16. The method of claim 15, wherein said enzyme substrate is selected from the group consisting of disodium 2-chloro-5-(4-methoxyspiro[1,2-dioxetane-3,2′-(5′-chloro)-tricyclo[3.3.1.1^{3,7}]decan]-4-yl)-1-phenyl phosphate and disodium 3-(4-methoxyspiro[1,2-dioxetane-3,2′(5′-chloro)-tricyclo-[3.3.1.1^{3,7}]decan]-4-yl)phenyl phosphate.

17. The method of claim 11, wherein said enhancer is selected from the group consisting of bovine serum albumin, human serum albumin and polymeric quaternary onium salts.

18. The method of claim 17, wherein said polymeric quaternary onium salts are selected from the group consisting of polyvinylbenzyltrimethyl ammonium chloride, polyvinylbenzyltributyl ammonium chloride, polyvinylbenzylbenzyldimethyl ammonium chloride, polyvinylbenzyltributyl phosphonium chloride, poly(benzyldimethylvinylbenzyl)ammonium chloride and sodium fluorescein and poly(benzyltributyl)ammonium chloride and sodium fluorescein.

19. The method of claim 11, wherein said cells are in a rich growth medium.

20. The method of claim 11, wherein said cells are in a minimal growth medium.

21. The method of claim 11, wherein said method is performed with 96- or higher density microplate format.

22. The method of claim 15, wherein said enzyme substrate is selected from the group consisting of 3-(2′-spiroadamantane)-4-methoxy-4-(3″-phosphoryloxy)phenyl-1,2-dioxetane, disodium salt, disodium 3-(4-methoxyspiro[1,2-dioxetane-3,2′-(5′-chloro)-tricyclo-[3.3.1.1^{3,7}]decan]-4-yl)phenyl phosphate, disodium 2-chloro-5-(4-methoxyspiro[1,2-dioxetane-3,2′-(5′-chloro)-tricyclo[3.3.1.1^{3,7}]decan]-4-yl)-1-phenyl phosphate, and disodium 2-chloro-5-(4-methoxyspiro[1,2-dioxetane-3,2′-(5′-chloro)-tricyclo[3.3.1.1^{3,7}]decan]-4-yl)-1-phenyl phosphate.

23. The method of claim 11, wherein said luminescence lasts 30 minutes or more.

24. A method for the quantitation of cells in a microwell cell culture or an aliquot of a sample comprising:
admixing cell lysis components and an enzyme substrate to form a reaction buffer,
adding said reaction buffer directly to said microwell cell culture or aliquot of a sample,
incubating said cell culture containing said reaction buffer,
adding an accelerator containing an enhancer to said microwell cell culture or aliquot of a sample, and
measuring any luminescence generated,
wherein said luminescence is as an indication of the activity of the corresponding endogenous enzyme, and
wherein said activity correlates to the number of cells present.

25. The method of claim 24, wherein said cells are mammalian cells.

26. The method of claim 25, wherein said enzyme substrate is a 1,2-dioxetane.

27. The method of claim 26, wherein said 1,2-dioxetane has the formula I: 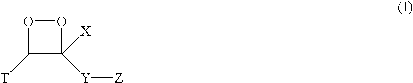
wherein T is a substituted or unsubstituted cycloalkyl ring having between 6 and 12 carbon atoms or a polycycloalkyl group bonded to the 4-membered dioxetane ring by a spiro linkage; Y is a fluorescent chromophore; X is hydrogen, a straight chain or branched chain alkyl or heteroalkyl group, an aryl group, a heteroaryl group, a heteroalkyl group, an aralkyl group, an alkaryl group, or an enzyme-cleavable group; Z is hydrogen, hydroxyl, or an enzyme-cleavable group;
provided that at least one of X or Z must be an enzyme-cleavable group;
wherein said enzyme-cleavable group is cleaved by said endogenous enzyme to thereby form a negatively charged group bonded to the dioxetane which decomposes to form a luminescing substance; and
wherein said negatively charged group includes the group Y.

28. The method of claim 24, wherein said endogenous enzyme is glucosidase.

29. The method of claim 28, wherein said enzyme substrate in Glucon™.

30. The method of claim 24, wherein said method is performed with 96- or higher density microplate format.

31. The method of claim 24, wherein said cells are adherent or suspension cells.

32. The method of claim 24, wherein said enhancer is selected from the group consisting of bovine serum albumen, human serum albumen and polymeric quaternary onium salts.

33. The method of claim 24, wherein said method is performed in the presence or absence of phenol red.

34. The method of claim 24, wherein said cell culture is incubated for an amount of time sufficient to achieve constant light emission.

35. A kit for conducting the assay of claim 1, wherein said kit comprises:
an enzyme substrate specific for said endogenous enzyme, which when contacted by said endogenous enzyme will be caused to decompose into a decomposition product that luminesces;
a reaction buffer comprising cell lysis components and an enhancer which enhances the amount of light released as compared to the amount of light released in the absence of said enhancer.

36. The kit according to claim 35, wherein said endogenous enzyme is alkaline phosphatase.

37. The kit according to claim 36, wherein said substrate is selected from the group consisting of 3-(2′-spiroadamantane)-4-methoxy-4-(3″-phosphoryloxy)phenyl-1,2-dioxetane, disodium salt, disodium 3-(4-methoxyspiro[1,2-dioxetane-3,2′-(5′-chloro)-tricyclo-[3.3.1.1^{3,7}]decan]-4-yl)phenyl phosphate, disodium 2-chloro-5-(4-methoxyspiro{1,2-dioxetane-3,2′-(5′-chloro)-tricyclo[3.3.1.1^{3,7}]decan]-4-yl)-1-phenyl phosphate, and disodium 2-chloro-5-(4-methoxyspiro[1,2-dioxetane-3,2′-tricyclo[3.3.1.1^{3,7}]decan]-4-yl)-1-phenyl phosphate.

38. The kit according to claim 35, wherein said enzyme substrate is a 1,2-dioxetane.

39. The kit according to claim 38, wherein said 1,2-dioxetane has the formula I: 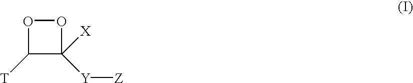
wherein T is a substituted or unsubstituted cycloalkyl ring having between 6 and 12 carbon atoms or a polycycloalkyl group bonded to the 4-membered dioxetane ring by a spiro linkage; Y is a fluorescent chromophore; X is hydrogen, a straight chain or branched chain alkyl or heteroalkyl group, an aryl group, a heteroaryl group, a heteroalkyl group, an aralkyl group, an alkaryl group, or an enzyme-cleavable group; Z is hydrogen, hydroxyl, or an enzyme-cleavable group;
provided that at least one of X or Z must be an enzyme-cleavable group;
wherein said enzyme-cleavable group is cleaved by said endogenous enzyme to thereby form a negatively charged group bonded to the dioxetane which decomposes to form a luminescing substance; and
wherein said negatively charged group includes the group Y.

40. The kit according to claim 35, wherein said enhancer is selected from the group consisting of bovine serum albumin, human serum albumin and polymeric quaternary onium salts.

41. The method of claim 40, wherein said polymeric quaternary onium salts are selected from the group consisting of polyvinylbenzyltrimethyl ammonium chloride, polyvinylbenzyltributyl ammonium chloride, polyvinylbenzylbenzyldimethyl ammonium chloride, polyvinylbenzyltributyl phosphonium chloride, poly(benzyldimethylvinylbenzyl)ammonium chloride and sodium fluorescein and poly(benzyltributyl) ammonium chloride and sodium fluorescein.

42. A kit for conducting the assay of claim 1, wherein said kit comprises:
an enzyme substrate specific for said endogenous enzyme, which when contacted by said endogenous enzyme will be caused to decompose into a decomposition product that luminesces;
a reaction buffer containing cell lysis components; and
an accelerator.

43. The kit according to claim 42, wherein said enzyme substrate is a 1,2-dioxetane.

44. The kit according to claim 43, wherein said 1,2-dioxetane has the formula I: 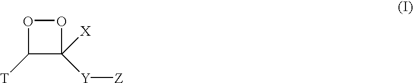
wherein T is a substituted or unsubstituted cycloalkyl ring having between 6 and 12 carbon atoms or a polycycloalkyl group bonded to the 4-membered dioxetane ring by a spiro linkage; Y is a fluorescent chromophore; X is hydrogen, a straight chain or branched chain alkyl or heteroalkyl group, an aryl group, a heteroaryl group, a heteroalkyl group, an aralkyl group, an alkaryl group, or an enzyme-cleavable group; Z is hydrogen, hydroxyl, or an enzyme-cleavable group;
provided that at least one of X or Z must be an enzyme-cleavable group;
wherein said enzyme-cleavable group is cleaved by said endogenous enzyme to thereby form a negatively charged group bonded to the dioxetane which decomposes to form a luminescing substance; and
wherein said negatively charged group includes the group Y.

45. The kit according to claim 42, wherein said endogenous enzyme is glucosidase.

46. The kit according to claim 45, wherein said enzyme substrate is Glucon™.

47. The kit according to claim 42, wherein said accelerator is polyvinylbenzyltributyl ammonium chloride.
